(19) United States
(12) Patent Application Publication
(10) Pub. No.: US 2013/0213763 A1
(43) Pub. Date: Aug. 22, 2013

(54) VALIDATOR AND BILL STACKER CONFIGURED TO STORE NOTES IN SEALING, TAMPER-EVIDENT BAGS WITHIN A CASH MANAGEMENT SAFE

(71) Applicant: Crane Payment Solutions Inc., (US)

(72) Inventors: Umesh Rao, Markham (CA); Oelksandr Lukonin, Etobicoke (CA); Viktor Rogachov, Toronto (CA); Sergiy Androsyuk, Toronto (CA); Dmytro Yermolenko, Etobicoke (CA); Mykhaylo Kucherenko, Maple (CA); Pierre Johann JiebenLiebenberg, Umbilo (ZA); Robert McDonald Tweedie, Durban (SA); Eric Abraham Kaled, Littleton, MA (US)

(73) Assignee: Crane Payment Solutions Inc., Salem, NH (US)

(21) Appl. No.: 13/848,531

(22) Filed: Mar. 21, 2013

Related U.S. Application Data
(63) Continuation of application No. 13/239,075, filed on Sep. 21, 2011.
(60) Provisional application No. 61/384,862, filed on Sep. 21, 2010.

(30) Foreign Application Priority Data
Sep. 21, 2011 (US) PCT/US2011/052605

(51) Int. Cl. G07D 11/00

(52) U.S. Cl. CPC G07D 11/0006; G07D 11/0069
USPC 194/350

(57) ABSTRACT

A cash management safe includes a bill validator and stacker and a bagging mechanism for sealing received bills in a tamper evident bag prior to allowing the safe to be opened. Deposited bills are sealed in the bag upon expiration of a predetermined accumulation period, when an unlock code is entered in the safe's door lock, or when the capacity of the bag has been reached. The bag is sealed and the contents reported to a remote cash management server prior to unlocking the safe door, to reduce opportunities for loss during subsequent transport of the tamper evident bag.

This application incorporates by reference U.S. patent application Ser. No. 13/239,075 filed Sep. 21, 2011 and entitled VALIDATOR AND BILL STACKER CONFIGURED TO STORE NOTES IN SEALING, TAMPER-EVIDENT BAGS WITHIN A CASH MANAGEMENT SAFE, and U.S. Provisional Patent Application No. 61/384,862 entitled AN APPARATUS FOR HOLDING AND SEALING TAMPER EVIDENT CASH DEPOSIT BAGS and filed on Sep. 21, 2010.

### TECHNICAL FIELD

The present application relates generally to retail cash safes and, more specifically, to cash management safes intrinsically validating deposited currency and avoiding any need for direct employee handling of deposited cash.

### BACKGROUND

Retail establishments such as convenience and grocery stores often handle significant quantities of cash, requiring security arrangements for preventing embezzlement or employee theft and minimizing potential losses from armed robbery. Many such establishments use cash-in-transit (CIT) or armored car services to handle cash transfers from the retail location(s) to a deposit institution such as a bank. In addition, many such enterprises employ a drop safe or depository safe (often referred to collectively as “cash management safes”) on the premises to store accumulated cash between CIT pickups and/or to dispense cash for use as change to customers. Existing cash management safes simply receive and hold cash collected by a cashier at a point of sale (POS) and deposited into the safe by an employee, often with individual bills in small tubes allowing the received bills (in their tubes) to be dispensed by the safe for re-use as change by employees.

Cash management safes generally house a removable canister or bag in which cash deposits during a predefined period are stored. The canister or bag is held within the cash management safe in a fixed position to receive bills dropped or otherwise inserted into the safe during the predefined period. A manager or CIT employee manually installs or changes the canisters or bags upon expiration of a deposit period, which are open when being removed from the safe. Any cash within the canister or bag is thus accessible at such times, leaving opportunities for loss and/or theft.

In addition, the capacity of a cash management safe is generally limited by the size of the canister or bag into which bills are inserted once deposited, regardless of the physical size of the safe. Despite any desire to maximize capacity, the canisters or bags must remain of physically manageable size. Therefore a cash management safe—particularly one using tubes to hold individual bills—is limited in the amount of accumulated cash that can be held. During high volume periods when accumulated cash rapidly exceeds the capacity of a single canister or bag, the canister or bag within the safe may need to be changed, with the full canister or bag either stored in another safe by an employee of the enterprise or picked up by the CIT service called for a special pickup or scheduled with greater than ordinary frequency. Alternatively multiple cash management safes must be provided at a single retail location. Any of those options increases risk of loss, expense and the complexity of the enterprise cash management procedures.

There is, therefore, a need in the art for improved cash management safes that are compact but provide significant capacity, and that hold deposited cash in containers that are sealed before removal from the safe.

### SUMMARY

A cash management safe includes a bill validator and stacker and a bagging mechanism for sealing received bills in a tamper evident bag prior to allowing the safe to be opened. Deposited bills are sealed in the bag upon expiration of a predetermined accumulation period, when an unlock code is entered in the safe's door lock, or when the capacity of the bag has been reached. The bag is sealed and the contents reported to a remote cash management server prior to unlocking the safe door, to reduce opportunities for loss during cash handling and transport.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a diagram of a system employing a cash management safe including a bill validator and stacker configured to store notes in sealing, tamper evident bags according to one embodiment of the present disclosure;

FIG. 2 is a side view of a bill validator and stacker with a bagging mechanism for holding and sealing tamper evident cash deposit bags according to one embodiment of the present disclosure;

FIG. 3 is a side section view of the stacker and bagging mechanism depicted in FIG. 2;

FIG. 4 is a perspective view of portions of the stacker depicted in FIG. 2;

FIG. 5 is a perspective view of the bagging mechanism depicted in FIG. 2;

FIGS. 5A and 5B illustrate how a tamper evident, heat-sealing bag is held by the bagging mechanism 204 depicted in FIG. 2;

FIG. 5C depicts a front view of one of the crossbars of the bagging mechanism depicted in FIG. 2;

FIGS. 6 and 6A-6B are perspective views of an alternate implementation of the bagging mechanism for holding and sealing tamper evident cash deposit bags beneath a bill validator and stacker according to another embodiment of the present disclosure;

FIGS. 7 and 7A-7C are various views of one bagging mechanism within the embodiment of FIGS. 6 and 6A-6B when components of the bagging mechanism are positioned for the bagging mechanism to receive bills;

FIGS. 8 and 8A-8C are various views of one bagging mechanism for the embodiment of FIGS. 6 and 6A-6B when components of the bagging mechanism are positioned for the bagging mechanism to seal the bag;

FIGS. 9 and 9A-9C are various views of one bagging mechanism for the embodiment of FIGS. 6 and 6A-6B when components of the bagging mechanism are positioned for the bagging mechanism to release the bag;

FIGS. 10A-10E are various views of the upper frame within a bagging mechanism according to an alternative embodiment of the present disclosure;

FIGS. 11A-11B are various views of a drive linkage coupling the lower frame within one bagging mechanism for the embodiment of FIGS. 10A-10E to drive motors;

FIG. 12 is a detail depicting use of a wire drive connection used within one bagging mechanism for the embodiment of FIGS. 10A-10E;

FIG. 13 is a high level flowchart of the operation of the bagging mechanism according to one embodiment of the present disclosure;

FIG. 14 is a block diagram of selected electrical and electronic components of a cash management safe including a bill validator and stacker configured to store notes in sealing, tamper evident bags according to one embodiment of the present disclosure; and

FIG. 15 is a high level flow chart of a process for operating a cash management safe including a bill validator and stacker configured to store notes in sealing, tamper evident bags according to one embodiment of the present disclosure.

### DETAILED DESCRIPTION

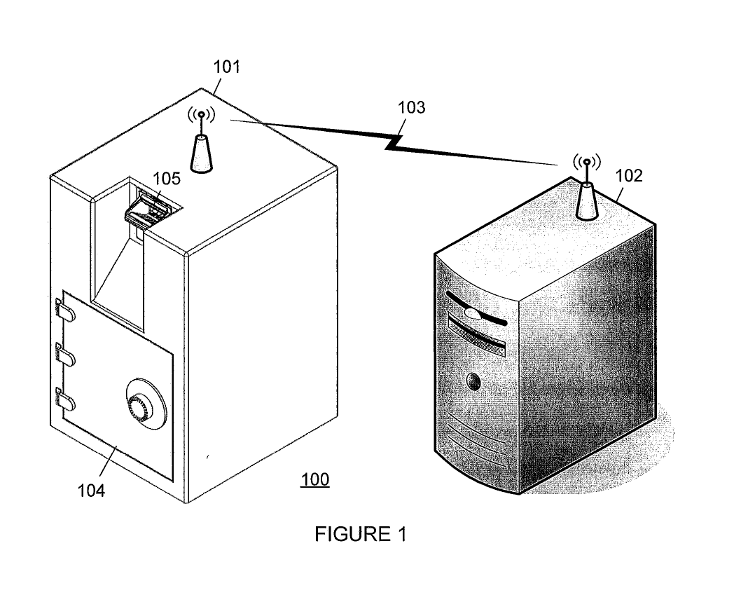

FIGS. 1 through 15, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged vending machine currency handling system.

FIG. 1 is a diagram of a system employing a safe including a bill validator and stacker configured to store notes in sealing, tamper evident bags according to one embodiment of the present disclosure. The system 100 includes a safe 101 including a bill validator receiving and validating currency as described in further detail below. The bill validator 102, or alternatively some other electronic component within safe 101, optionally communicates via communication link 103 with an enterprise cash management program executing on a remote server 104. The communication link 103 in the exemplary embodiment is a wireless connection constituting part of a wide area network (WAN), but may alternatively be any suitable wired or wireless transmission medium directly coupling the safe 101 to a remote enterprise computer system 104 running the enterprise cash management program. Communication link 103 may also be a wired or wireless connection between the safe 101 and a handheld device employed by an employee of a CIT service picking up cash from the establishment using the safe 101 and between the handheld device and the enterprise computer system 104 running the enterprise cash management program. Still further, the communication link 103 may be a removable storage medium (e.g., a flash drive) retrieved by the CIT service employee together with cash from the safe 101, and installed in the enterprise computer system 104 running the enterprise cash management program. Regardless, by way of the communication link 103, the bill validator 102 transmits information regarding cash received, validated, and stored within safe 101 since the last pickup by the CIT service. The information communicated may include the various denominations and the numbers of each denomination of currency stored within the bill validator 102 and picked up by the CIT service.

The exterior of safe 101 is formed by a secure enclosure having a locking access door 104 as illustrated in FIG. 1. A slot 105 for receiving bills to be processed and stored is exposed outside the secure enclosure and is accessible from the exterior near an upper end of the safe 101. (The terms “bills,” “notes” and “currency” are used interchangeably herein to refer to paper currency). Preferably the slot 105 includes an associated banknote stack receiving structure adapted to receive bills in bulk, such as that described in U.S. Patent Application Publication No. 2009/0314839, which is hereby incorporated by reference. However, a slot receiving bills individually may also be used.

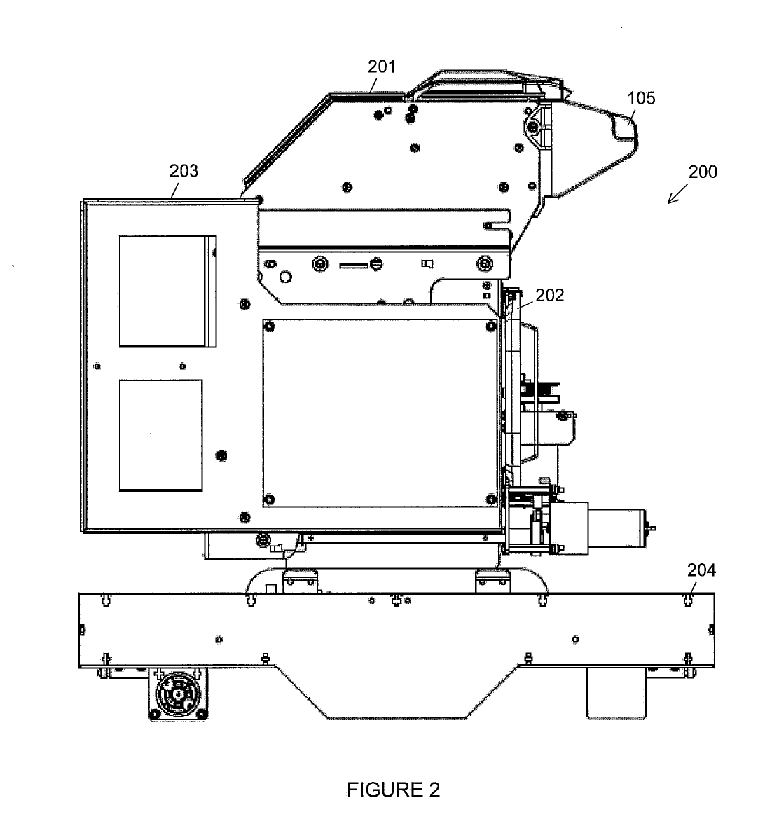

FIG. 2 is a side view of a bill validator and stacker with a bagging mechanism for holding and sealing tamper evident cash deposit bags according to one embodiment of the present disclosure. The assembly 200 depicted in FIG. 2 is mounted within the secure enclosure forming the exterior of safe 101, with the slot 105 accessible from the exterior and the associated banknote stack receiving structure projecting externally from an outer surface of the secure enclosure. The bill validator 201 is located at the top of the assembly 200 and is fixed mounted to the top of the stacker mechanism 202. Bills inserted into slot 105 are validated by the bill validator 201 in accordance with the known art. If rejected, the bills are returned through slot 105. If accepted, the inserted bills pass through the bill validator 201 and are inserted into the stacker 202 through aligned opening in the bottom of bill validator 201 and the top of stacker 202.

Mounting brackets 203 on either side of the stacker mechanism 202 allow the bill validator 201 and stacker mechanism 202 to be secured to an internal surface of the secure enclosure forming the outside of safe 101. Below the stacker mechanism 202 is a bagging device 204 receiving bills from stacker mechanism 202 in a bag held thereon and sealing the received bills within the bag in a tamper evident manner as described in further detail below.

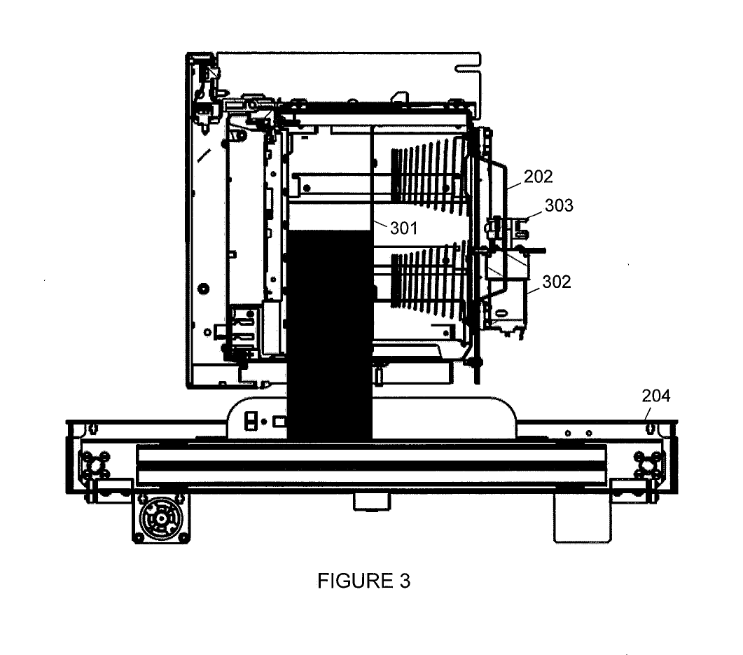

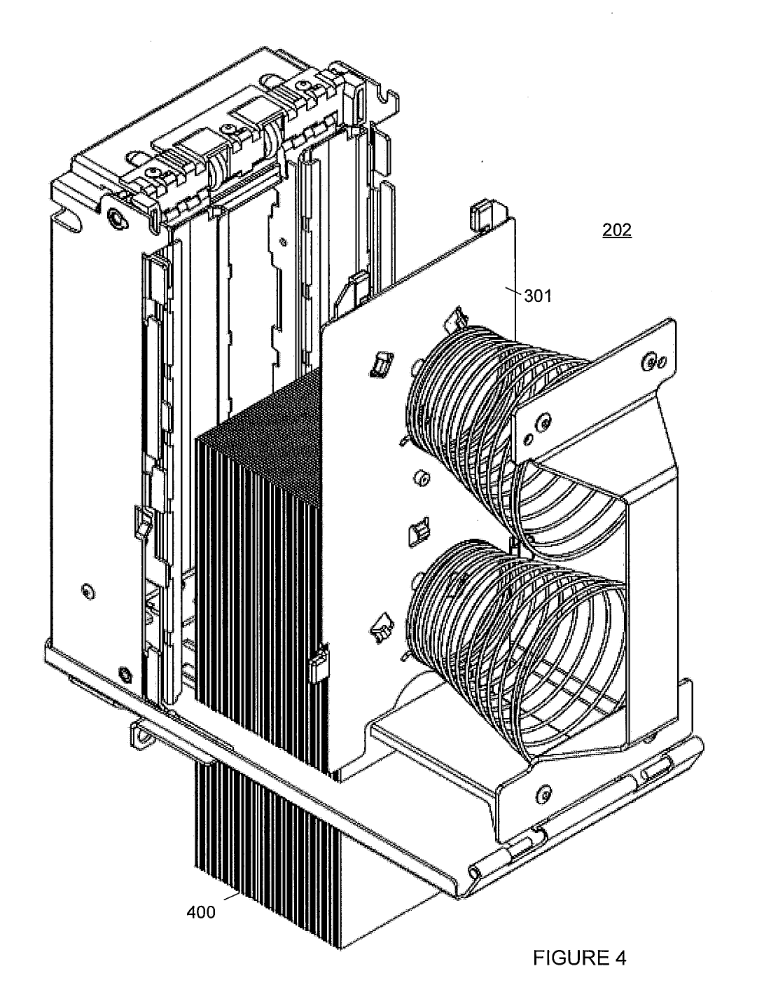

FIG. 3 is a side section view of the stacker 202 and bagging mechanism 204 depicted in FIG. 2, and FIG. 4 is a perspective view of portions of the stacker 202. Both views depict a stack of bills 400 during transition between the stacker 202 and the bagging mechanism 204. Stacker mechanism 202 is based on the construction and principles of operation disclosed in U.S. Pat. No. 5,730,271, which is incorporated herein by reference. Each of the bills within the stack 400 is individually received from the bill validator 201 through an opening on top of stacker 202 into a pair of guides holding the bill along the vertical edges. The guides also form keeper faces that hold a stack of bills in compression against a spring-biased support plate 301.

A pusher is movable within the area separating guides between retracted and extended positions, where the face of pusher is on the opposite side of guides from the support plate 301 (and any bills held between support plate 301 and keeper faces) when the pusher is in the retracted position and presses bills against the support plate 301 when the pusher is in the extended position. The pusher is moved to the retracted position each time a bill is inserted into stacker 202 by the bill validator 210. Once a bill has been inserted and is held by guides, the pusher is moved to the extended position, pushing the received bill out of guides and onto the stack of bills held between support plate 301 and the pusher (or between support plate 301 and keeper faces when the pusher is in the retracted position). Received bills are thus maintained in a “stacked” arrangement (albeit with the bills in a vertical orientation) within stacker 202, held in compression between support plate 301 and either pusher or keeper faces.

A drop opening is positioned below the stack of bills within stacker 202 and above a bag held by bagging mechanism 204. The drop opening may optionally be controllable covered by a movable door, to prevent access into the stacker 202 and/or selectively retain bills within stacker 202. When a stack of bills is dropped from the stacker 202 into a bag below held by the bagging mechanism 204 through the drop opening, the door must of course be open.

A retracting motor 302 mounted on a surface of stacker 202 near the support plate 301 selectively drives a drum 303 having one end of a cable wound therearound. The opposite end of the cable is secured to support plate 301, so that the retracting motor 302 may be employed to selectively retract support plate 301 against the biasing force of the springs away from the pusher and keeper faces. Once the support plate 301 has been retracted a sufficient distance, the stack of vertical bills will no longer be held in compression between the support plate 301 and pusher and/or keeper faces, and will be free to drop under influence of gravity through the drop opening into the bag held by the bagging mechanism 204. Once the bill stack has been released, the motor 302 may be reverse to allow the support plate 301 to return to the normal position for stacking accumulated bills. The range of motion of the support plate 301 may be solely controlled by motor 302 or may be limited by stops.

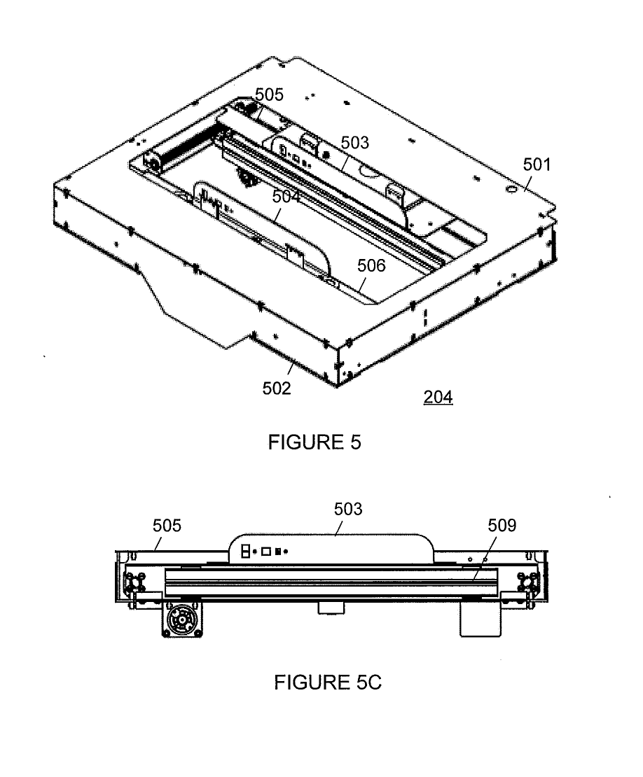

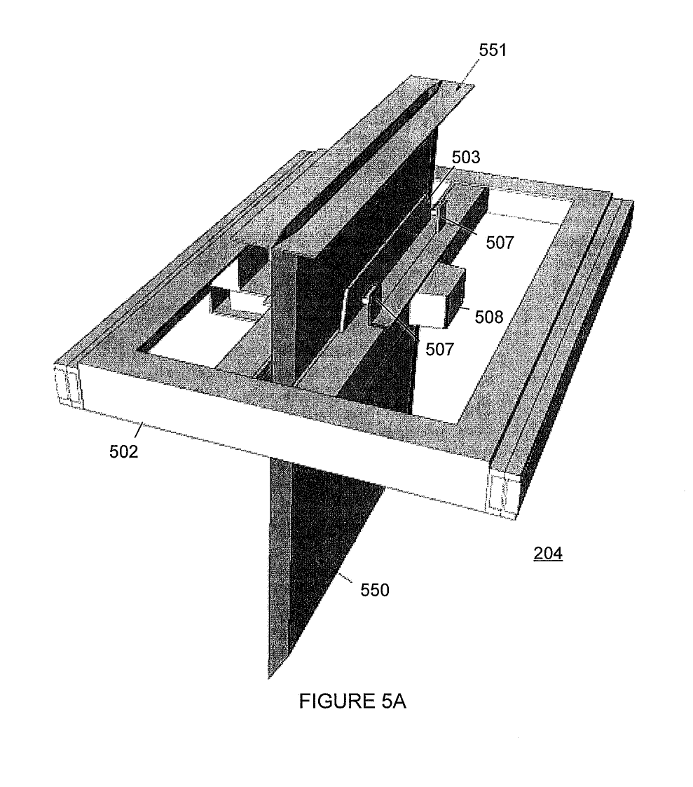

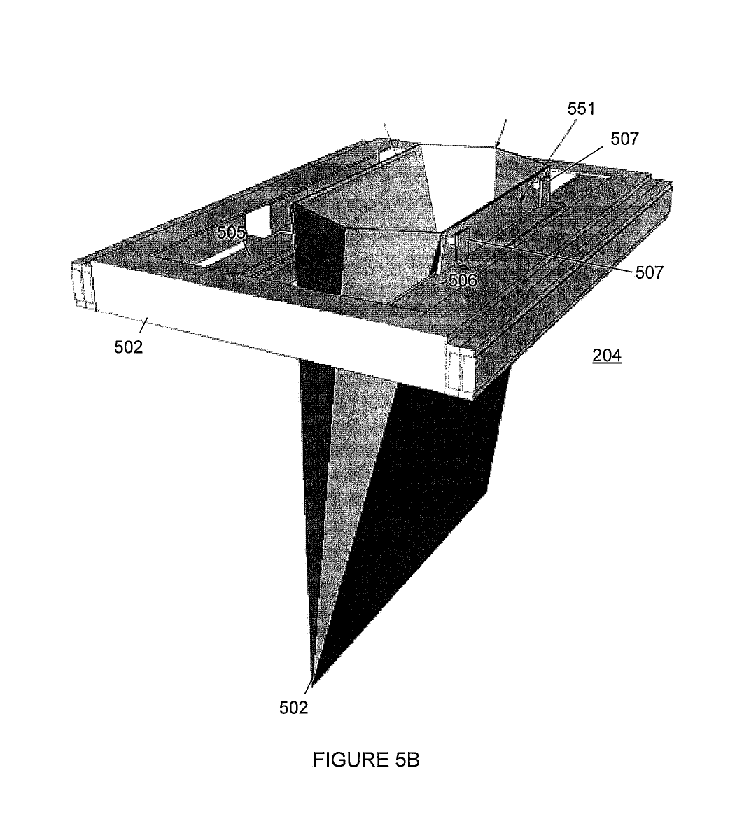

FIG. 5 is a perspective view of the bagging mechanism 204 depicted in FIG. 2. The bagging mechanism 204 includes a shroud 501 over a rectangular support frame 502 by which the bagging mechanism 204 is mounted to internal surfaces of the safe 101, below the bill validator 201 and stacker 202 but above the uppermost edge of the locking door 104. The shroud 501 completely covers the horizontal cross-sectional area within the safe 101 except for an opening between support tabs 503 and 504, and thus limits access to the portion of safe housing bill validator 201 and stacker 202 through the opening into the safe 101 when the locking door 104 is open.

Support tabs 503 and 504 are secured to crossbars 505 and 506, respectively, mounted within the support frame 502 over which shroud 501 is fitted. In the exemplary embodiment, one of crossbars 505 and 506 slides along the support frame while the other is fixed in position; however, crossbars 505 and 506 may alternatively both be made to slide along rails within the support frame 502. A motor and worm drive or similar drive mechanism open or close crossbars 505 and 506 and the support tabs 503 and 504 mounted thereon.

FIGS. 5A and 5B illustrate how a tamper evident, heat-sealing bag is held by the bagging mechanism 204 depicted in FIG. 2. Tamper evident, heat-sealing bag 550 is an elongate, expandable envelope closed on three sides and preferably made of a water-proof material with at least the top portion (the portion around the open side) comprising a thermo-setting plastic or resin-infused fiber material that will soften and/or partially melt at predetermined temperatures above room temperature. The material selected should resist tearing or cutting. The bag 550 is formed with an upper lip 551 adapted to fold over around an exterior of the bag 550.

During insertion of a bag 550 into bagging mechanism 204, the crossbars 505 and 506 and the support tabs 503 and 504 are positioned a slight distance apart, with sufficient space in between for bag 550 to be inserted. The upper lip 551 of bag 550 is folded over and fit around support tabs 503 and 504. Clamps 507 are then moved by drive mechanism 508 mounted on the corresponding crossbar 505 or 506 to secure the upper lip 551 folded over the support tabs 503 and 504 to the respective support tabs 503 and 504. (While only the clamps 507 and drive mechanism 508 for support tab 503 are visible in FIG. 5A, the same structures are provided for support tab 502). The upper lip 551 of bag 550 is thus secured between support tabs 503 and 504 and clamps 507, holding the bag in place while bills are dropped into the bag 550 from the stacker 202.

FIG. 5C depicts a front view of one of the crossbars 505 and 506 of the bagging mechanism 204 depicted in FIG. 2. Each crossbar 505 and 506 includes a heat-sealing element 509 mounted below the respective support tab 503 or 504, positioned to contact a surface the bag 550 when a bag is supported by support tabs 503 and 504. The heat-sealing element 509 is selectively connected to a power source by switches, an electrical transformer, and electrical wiring (not shown), and enables heat-sealing of the tamper evident cash deposit bag 550 within bagging mechanism 204. When the crossbars 505 and 506 are in a sealing position—that is, against each other, separated only by portions of a bag 550 in between—and the heat-sealing elements 509 are energized, heat from the heating elements 509 will cause the portions of the bag 550 contacted by the heat-sealing elements 509 to soften and partial melt. When the heat-sealing elements 509 are subsequently turned off, the material of the bag 550 that had been contacted by the heating elements 509 will resume a normal, solid (but flexible) state, but will be melted together. The open end of the bag 550 will thus be sealed, together with the contents inside.

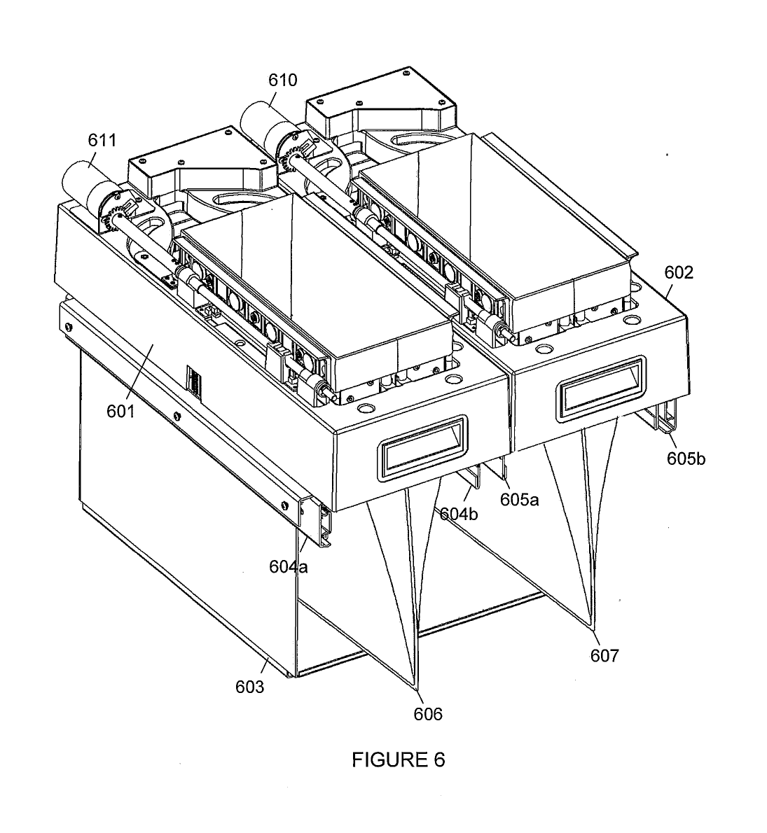

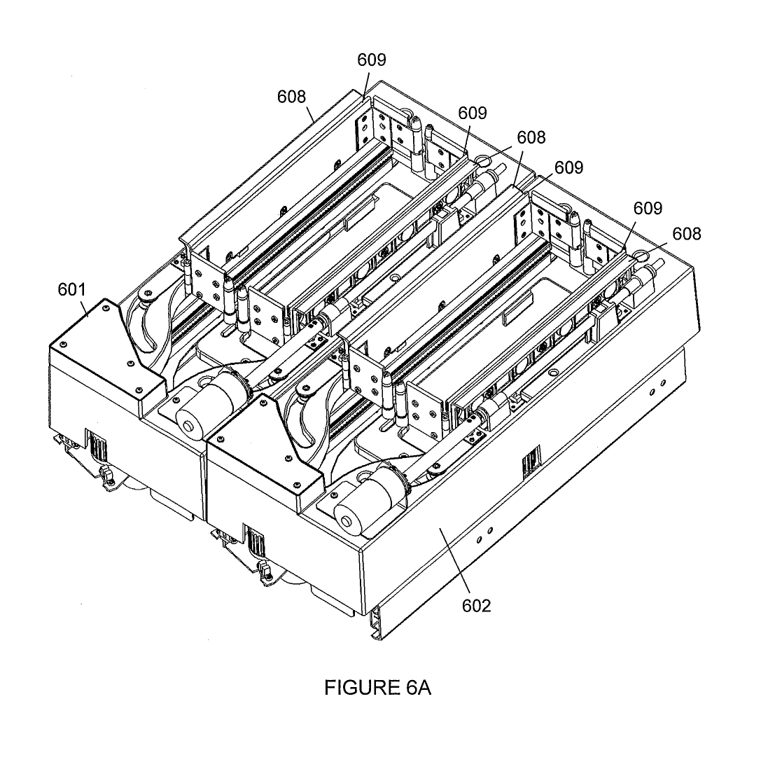

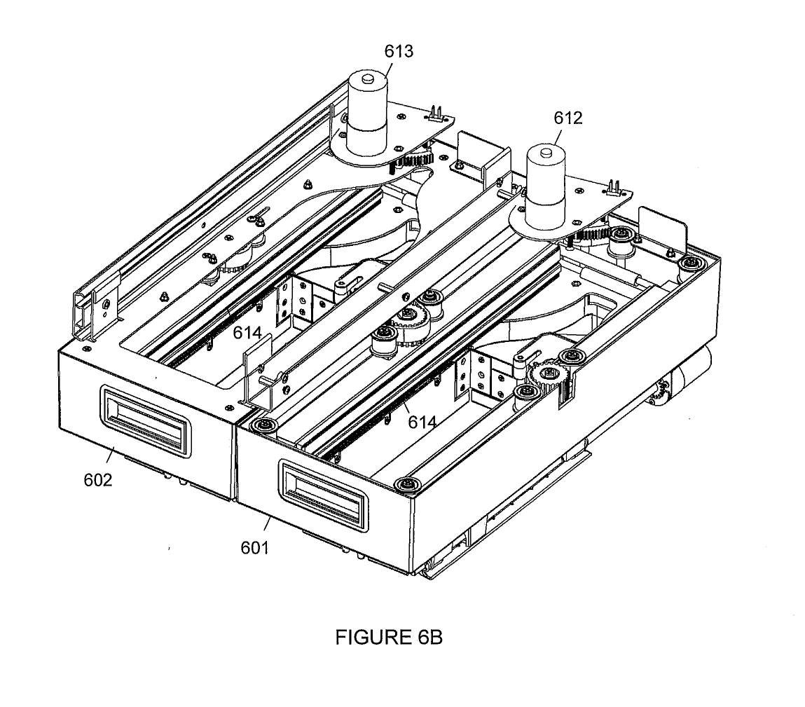

FIGS. 6 and 6A-6B are perspective views of an alternate implementation of the bagging mechanism for holding and sealing tamper evident cash deposit bags beneath a bill validator and stacker according to another embodiment of the present disclosure. In the embodiment of FIGS. 6 and 6A-6B, two bagging mechanisms are provided, and may each be position below a different bill validator and stacker. FIGS. 6A and 6B are rear upper and front lower perspective views, respectively, without the support structure and bags depicted in FIG. 6.

The two bagging mechanisms 601, 602 are essentially identical. Each bagging mechanism 601, 602 is slidably mounted on a support frame 603, which is a generally U-shaped structure of metal or plastic in the exemplary embodiment depicted. Each bagging mechanism 601, 602 is held by a pair of retractable slide tracks 604a, 604b and 605a, 605b of the type known in the art, allowing the bagging mechanism 601, 602 to be individually and separately pulled from a retracted position to an extended position for loading and unloading bags. Each bagging mechanism 601, 602 includes a shroud over a rectangular support frame by which the bagging mechanisms are mounted to internal surfaces of the safe 101, below the bill validator 201 and stacker 202 but above the uppermost edge of the locking door 104. The shrouds in combination completely cover the horizontal cross-sectional area within the safe 101 except for opening between support tabs on the respective bagging mechanisms, and thus limit access to the portion of safe housing bill validator 201 and stacker 202 through the opening into the safe 101 when the locking door 104 is open. The shroud around each bagging mechanism 601, 602 includes a recessed handle on the front face for use in pulling the bagging mechanism 601, 602 into the extended position from the retracted position.

Each bagging mechanism 601, 602 holds a tamper evident, heat-sealing, elongate, expandable envelope or bag 606 and 607 of the type described above. The folded-over top edges of the bags 606, 607 are held in compression between support tabs 609 and movable clamps 608. Each bagging mechanism 601, 602 includes a motor 610, 611 coupled by a mechanical linkage to the clamps and selectively operated by a control system to move the clamps toward or away from the support tabs. The clamps are moved away from the support tabs to allow the folded over edge of a bag to be inserted between each support tab and the neighboring clamp, then moving against the support tab to hold the bag material in compression between the clamps and support tabs.

Each bagging mechanism 601, 602 includes support tabs secured to crossbars mounted within the support frame over which shrouds are fitted. In the exemplary embodiment, the crossbars each slide in tandem along the support frame toward or away from each other; however, one crossbar may alternatively be made to slide along rails within the support frame while the other is fixed in position. A motor and worm drive or similar drive mechanism open or close crossbars and the support tabs mounted thereon. Each bagging mechanism 601, 602 also includes a motor 612, 613 coupled by a mechanical linkage to both the support tabs 609 and heating platens 614, all of which are movable mounted. A control system selective operates the motors 612, 613 to move the support tabs 609 (and clamps 608) and heating platens 614 for a respective bagging mechanism toward or away from each other. As discussed herein, the support tabs/clamps and heating platens are moved toward away from each other when the respective bagging mechanism is used to receive bills from the bill validator, and toward each other for sealing a bag.

Tamper evident, heat-sealing bags are elongate, expandable envelopes closed on three sides and preferably made of a water-proof material with at least the top portion (the portion around the open side) comprising a thermo-setting plastic or resin-infused fiber material that will soften and/or partially melt at predetermined temperatures above room temperature. The material selected should resist tearing or cutting. The bags are formed with an upper lip adapted to fold over around an exterior of the bag.

During insertion of a bag into one of the bagging mechanisms 501, 502, the crossbars and the support tabs are positioned a slight distance apart, with sufficient space in between for the bag to be inserted. The upper lip of the bag is folded over and fit around support tabs. Clamps are then moved by drive mechanism mounted on the corresponding crossbar to secure the upper lip folded over the support tabs to the respective support tabs. The upper lip of the bag is thus secured between support tabs and clamps, holding the bag in place while bills are dropped into the bag from the stacker 202.

Each crossbar includes a heat-sealing element mounted below the respective support tab, positioned to contact a surface the bag when a bag is supported by support tabs. The heat-sealing element is selectively connected to a power source by switches, an electrical transformer, and electrical wiring (not shown), and enables heat-sealing of the tamper evident cash deposit bag within bagging mechanism 204. When the crossbars are in a sealing position—that is, against each other, separated only by portions of a bag in between—and the heat-sealing elements are energized, heat from the heating elements will cause the portions of the bag contacted by the heat-sealing elements to soften, partially melt and fuse. When the heat-sealing elements are subsequently turned off, the material of the bag that had been contacted by the heating elements will resume a normal, solid (but flexible) state, but will be melted (fused) together. The open end of the bag will thus be sealed, together with the contents inside.

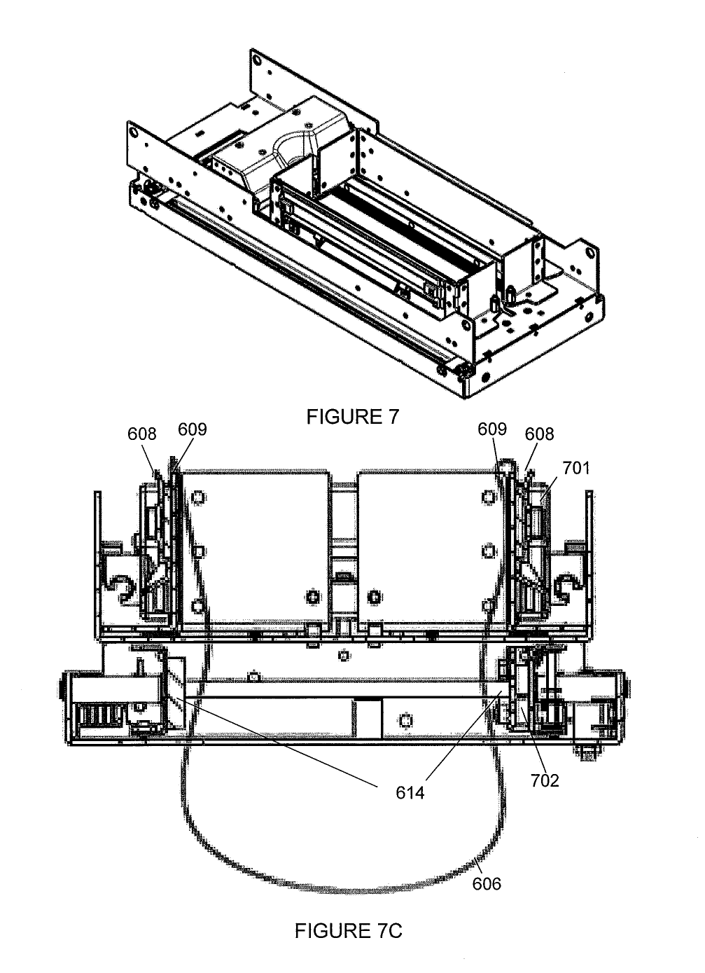

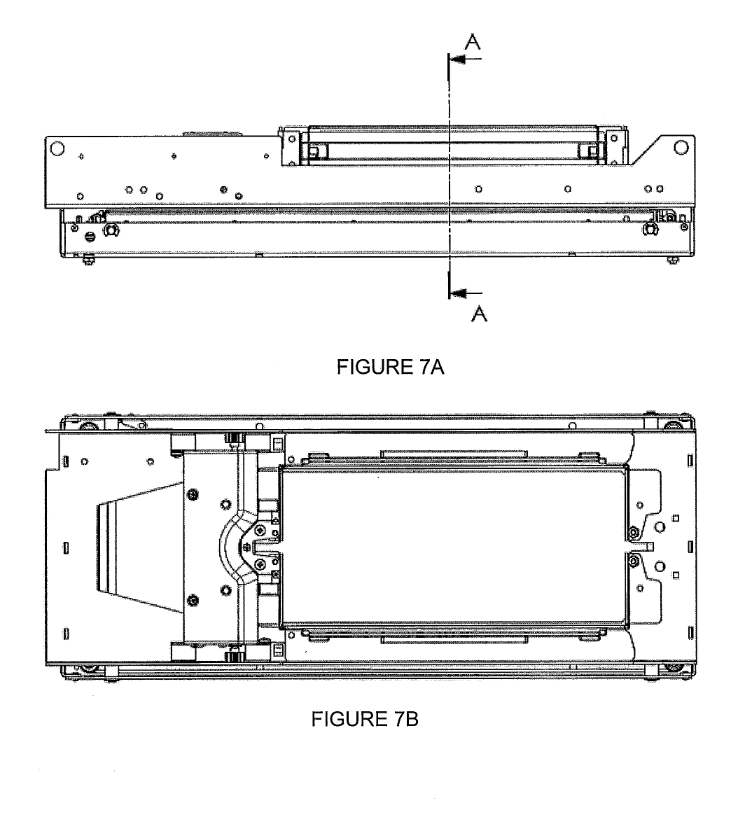

FIGS. 7 and 7A-7C are various views of one bagging mechanism within the embodiment of FIGS. 6 and 6A-6B when components of the bagging mechanism are positioned for the bagging mechanism to receive bills. FIG. 7 is a perspective view of the bagging mechanism, which may be either of bagging mechanisms 601 or 602 in FIGS. 6 and 6A-6B. FIG. 7A is a side view and FIG. 7B is a top plan view of the bagging mechanism of FIG. 7, while FIG. 7C is a side sectional view taken at section lines A-A in FIG. 7A. The support tabs 609 and clamps 608 are mounted on an upper movable frame 701, while the heating platen(s) 614 (actually a single heating platen and a counterpart block in the example depicted, but referred to as “heating platen(s)” herein for convenience) are mounted on a lower movable frame. The bag 606 is secured at an upper end between support tabs 609 and clamps 608, each pair of which (one support tab and one clamp) are spaced as far apart from the other pair as possible when the bagging mechanism components are in position to receive bills, as shown. The bag 606 hangs down between hearing platen(s) 614, which are also spaced as far apart as possible when the bagging mechanism components are in position to receive bills.

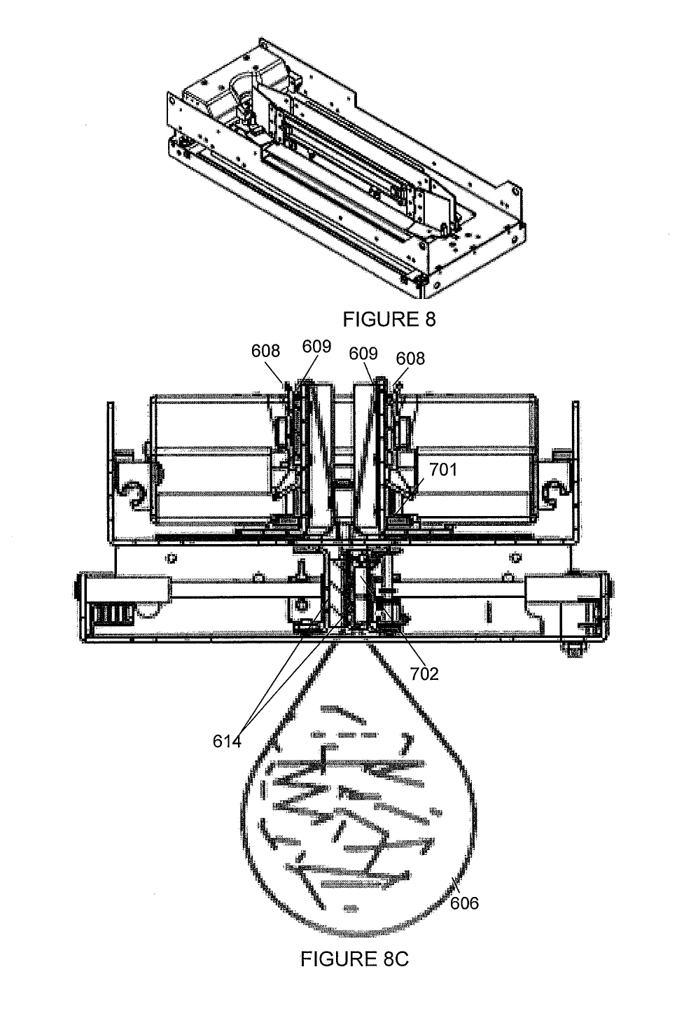

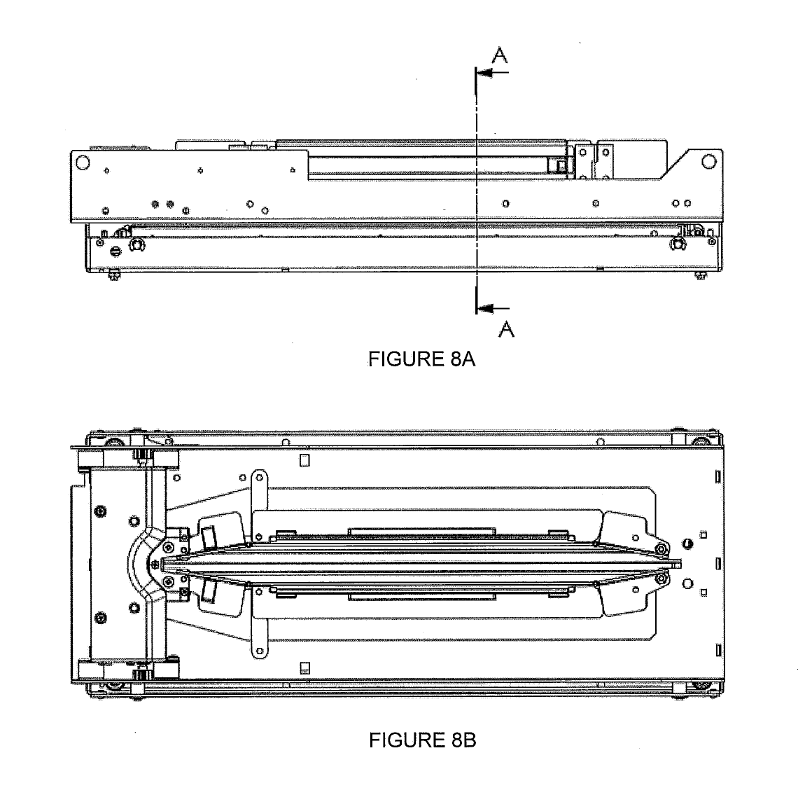

FIGS. 8 and 8A-8C are various views of one bagging mechanism for the embodiment of FIGS. 6 and 6A-6B when components of the bagging mechanism are positioned for the bagging mechanism to seal the bag. FIG. 8 is a perspective view of the bagging mechanism, which may be either of bagging mechanisms 601 or 602 in FIGS. 6 and 6A-6B. FIG. 8A is a side view and FIG. 8B is a top plan view of the bagging mechanism of FIG. 8, while FIG. 8C is a side sectional view taken at section lines A-A in FIG. 8A. When the bagging mechanism components are in position to seal the bag, the pairs of support tabs 609 and the clamps 608 are moved close together, and the heating platen(s) 614 are moved as closed together as possible with just the bag material in between. A control system supplies power to the heating platen(s) which heat and seal the bag in the manner described herein. Two motors are used to close the heating platen(s), each applying driving force at one end of both heating platen(s) 614 to push them together, in order to achieve the pressure profile along the lengths of the heating platen(s) that results in superior sealing of the bag.

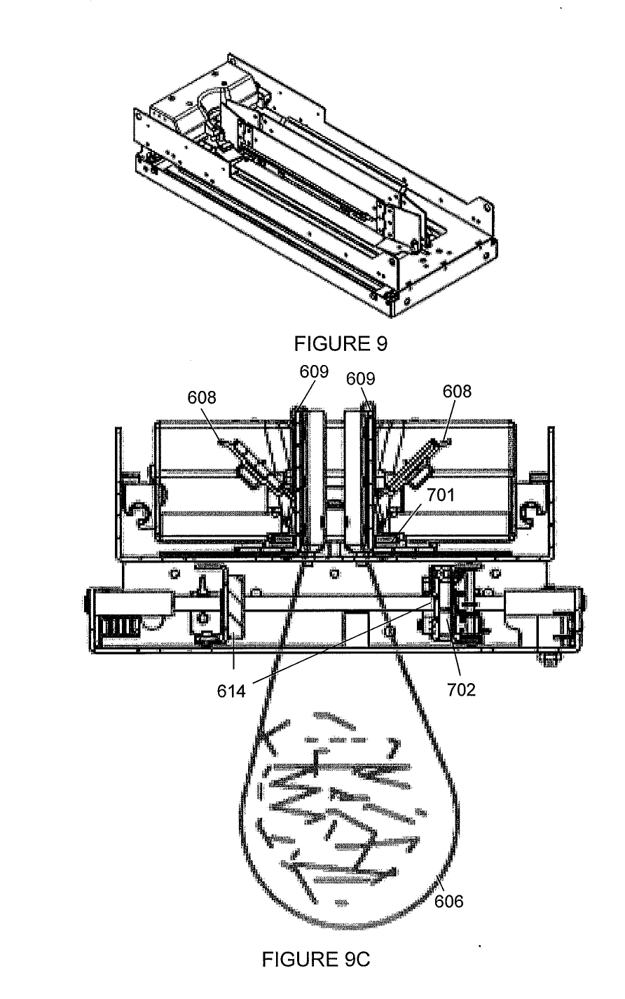

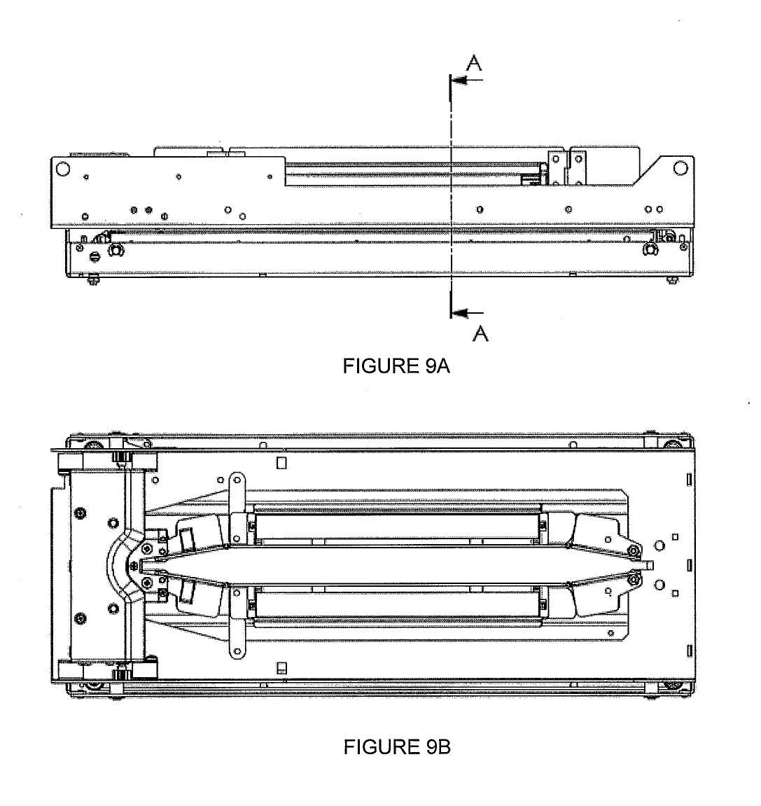

FIGS. 9 and 9A-9C are various views of one bagging mechanism for the embodiment of FIGS. 6 and 6A-6B when components of the bagging mechanism are positioned for the bagging mechanism to release the bag. FIG. 9 is a perspective view of the bagging mechanism, which may be either of bagging mechanisms 601 or 602 in FIGS. 6 and 6A-6B. FIG. 9A is a side view and FIG. 9B is a top plan view of the bagging mechanism of FIG. 9, while FIG. 9C is a side sectional view taken at section lines A-A in FIG. 9A. As shown, to release the bag 606 (which would normally be sealed when released, but is not shown as sealed in FIG. 9C), the heating platen(s) 614 are again moved as far away from each other as possible, leaving room for the bag 606 to drop between them. The pairs of support tabs 609 and clamps 608 remained positioned near each other, but each clamp 609 is rotated away from the neighboring support tab 608. The allows the upper material for the bag 606, no longer held in compression between the clamps 608 and support tabs 609, to slide over and around the top edge of the support tabs 609. The bag may thus drop under the influence of gravity due to its own weight (including the contents) or may alternatively be grasped near the bottom and pulled down.

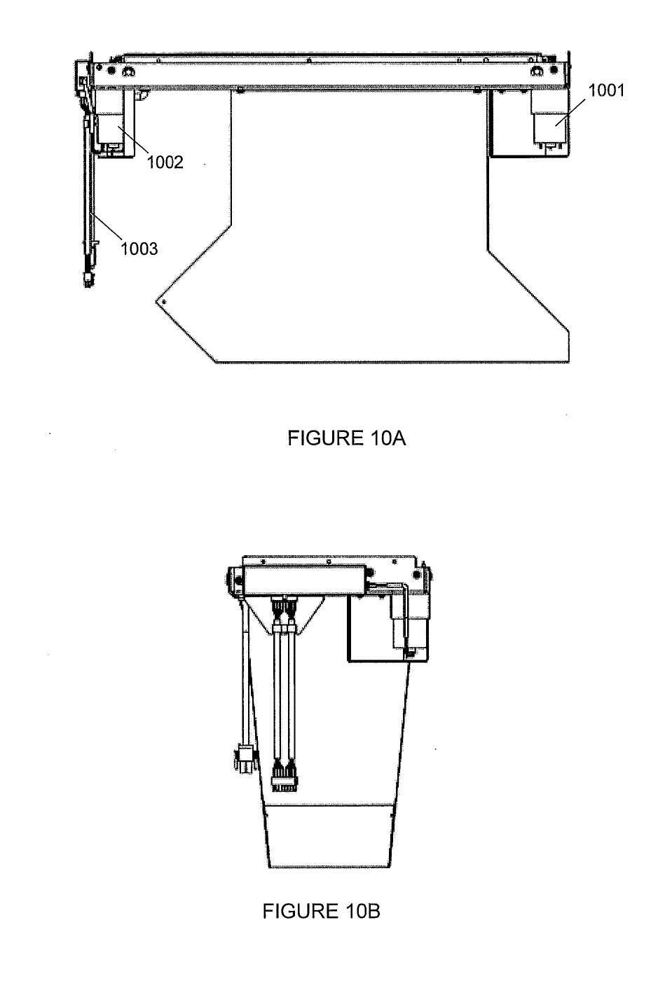

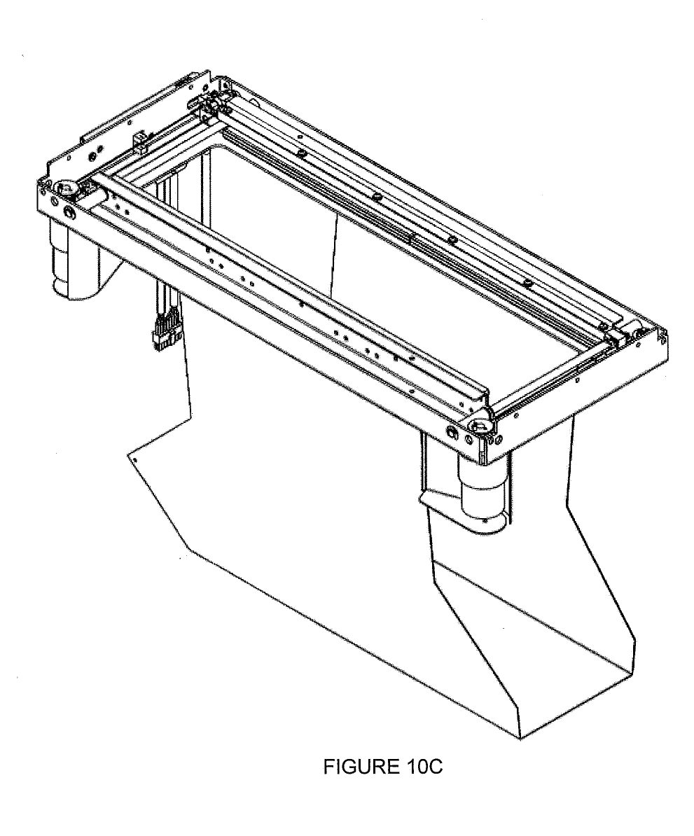

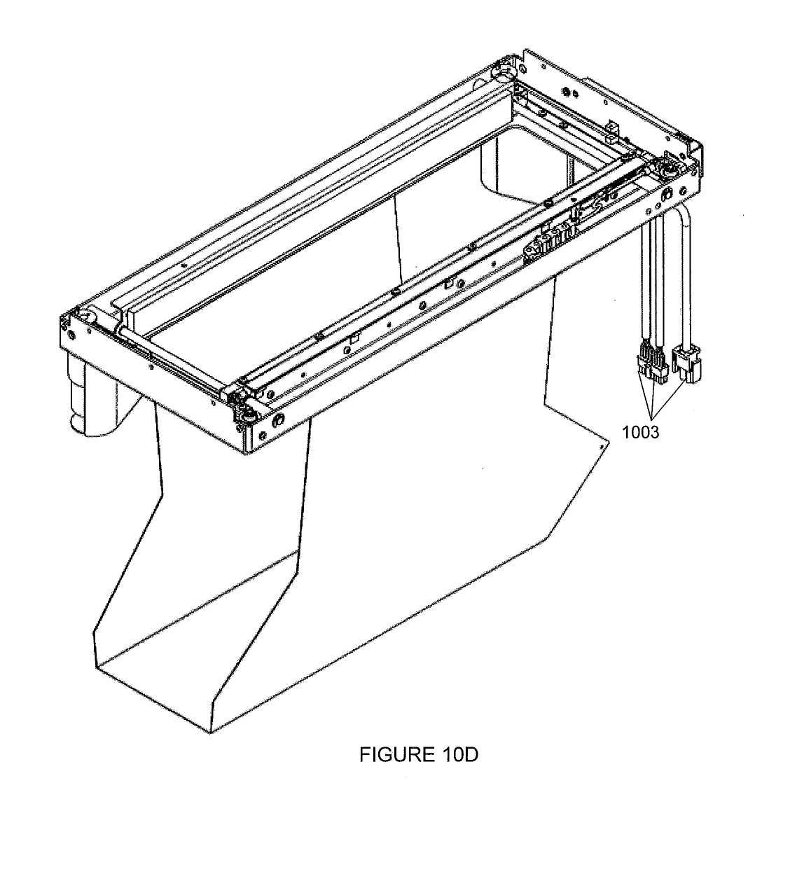

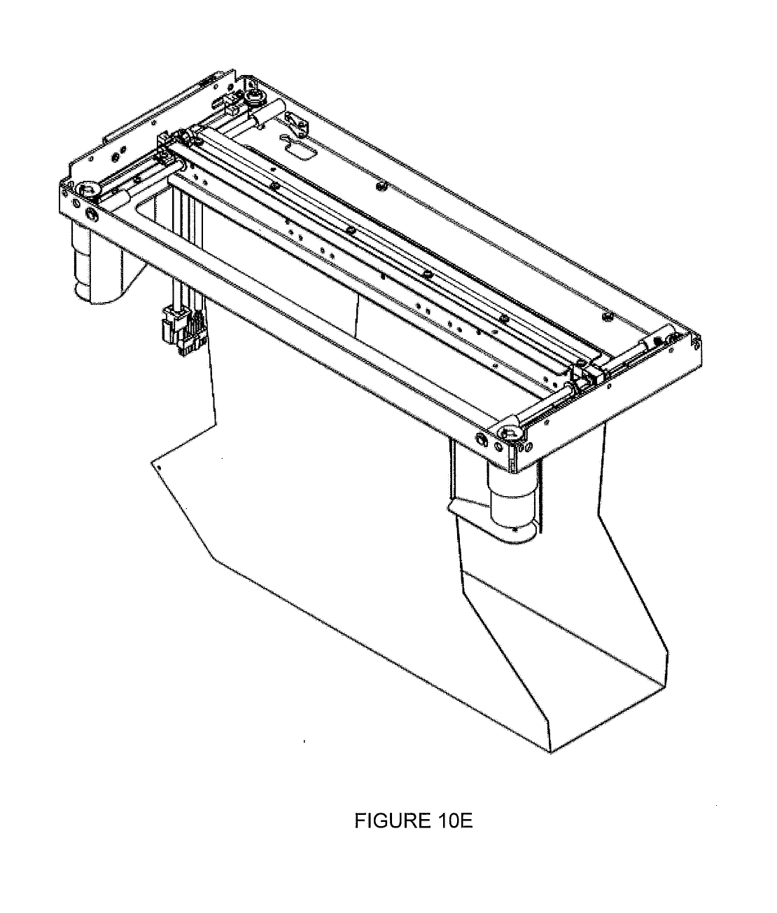

FIGS. 10A-10E are various views of the upper frame within one bagging mechanism for an alternate embodiment 6B the present disclosure. Two bagging mechanisms of the embodiment of FIGS. 10A-10E are held in a support frame covered by a shroud in the manner described above. Likewise bags are held, filled, sealed and released in the manner described above. However, the mechanisms for moving the cross bars differs from that previously depicted and described. FIG. 10A is a side view of the upper frame with a bag held (with portions of the bag cut away for clarity), while FIG. 10B is an end view. FIGS. 100 and 10D are different perspective views with the movable crossbars for the upper frame separated, while FIG. 10E is a perspective view with the movable crossbars together. The movable crossbar portions of the upper frame support and move the support tabs and clamps used to hold the bag. Two motors 1001 and 1002 are provided for moving the crossbars. In addition, downwardly projecting arms 1003 are provided for moving corresponding crossbars supporting the heating platen(s) on the lower frame. As illustrated by FIGS. 10C-10D and 10E, the crossbars on the upper frame may be moved independently of the crossbars on the lower frame. Movement of the crossbars is coordinated by a control system to position the support tabs, clamps and heating platen(s) as described above, for various purposes.

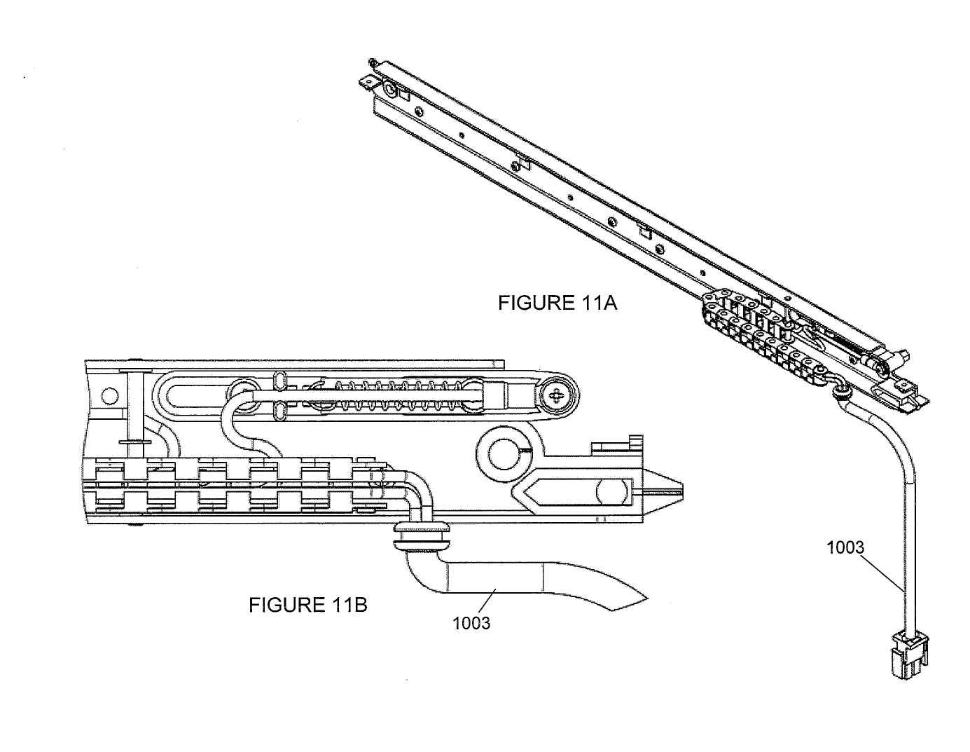

FIGS. 11A-11B are various views of a drive linkage coupling the lower frame within one bagging mechanism for the embodiment just described. The downwardly projecting arm(s) 1003 are coupled by a drive linkage to motors mounted on the upper frame, allowing the movable crossbars on the lower frame (and the heating platen(s) mounted thereon) to be selectively moved by those motors. As discussed above, two motors are used to drive the heater platen(s) rather than just one, which improves the overall quality of bag seals created by the heating platen(s) by an order of magnitude.

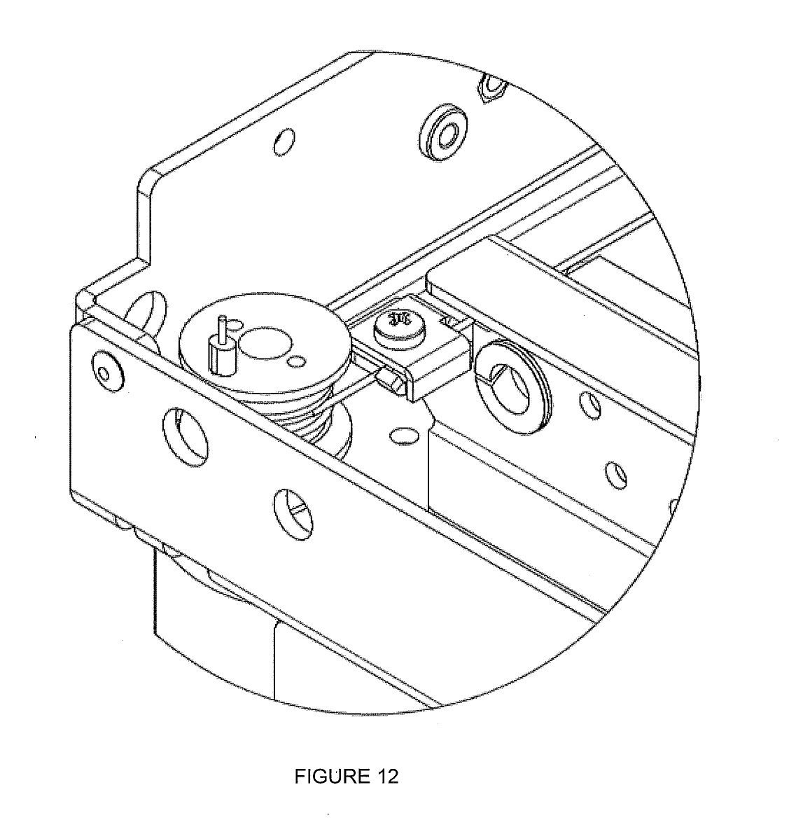

FIG. 12 is a detail depicting use of a wire drive connection used within one bagging mechanism for the embodiment of FIGS. 10A-10E. Instead of drive belts, wires with winding and drawing pulleys are used to move crossbars or other movable components, with a segment of the wire secure to the member to be moved. Improved control over movement and over the generation of force between members moved against each other by the motors is achieved with that drive configuration.

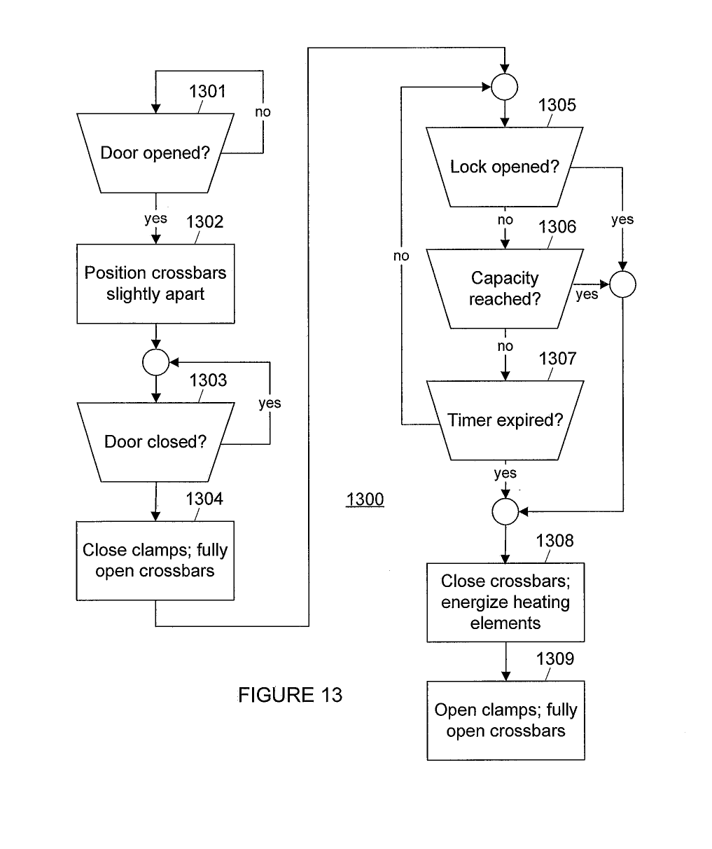

FIG. 13 is a high level flowchart of the operation of the bagging mechanism according to one of the embodiments of the present disclosure. When the process 1300 illustrated begins, any bag 550, 606 or 607 that had been held by the bagging mechanism has previously been sealed and released to drop from the bagging mechanism as described in further detail below, and the crossbars (support tabs) and clamps are in a release position (clamps open, crossbars fully separated). The process begins by determining, based on a door sensor, whether the door 104 to safe 101 has been opened (step 1301) from a previously closed state. When the door is opened, the crossbars are positioned slightly apart (step 1302), with enough space in between to allow proper insertion of an empty bag and with the clamps open. In this bag receiving or fitting position, the tamper evident cash deposit bag may be fitted to the bagging mechanism.

An employee of the enterprise using safe 101 or a CIT service person installs an empty bag within the bagging mechanism of the safe, fitting the folded over upper lip of the bag over support tabs and between the clamps and the support tabs. The safe door 104 is then closed. Upon detecting closure of the safe door (step 1303) from a previously open state, the clamps are closed (step 1304) to secure the bag in place, and then the crossbars are moved to a fully open position in which the open end of the bag is stretched open to receive bills dropped from the stacker.

The clamps remain closed and the crossbars remain fully open until the correct lock combination is entered (step 1305), the maximum capacity for the bag is reached (step 1306), or the predetermined period during which cash is to be accumulated has expired (step 1307). Upon occurrence of any of those events, the crossbars are “closed” (step 1309), brought as close together as possible with two sides of the open bag in between under compression, and the heat-sealing elements are energized for a predetermined period sufficient to cause material within both sides of the bag to melt together and seal the open end. At that end of that period, the clamps are opened and the crossbars are fully opened, at which time the weight of the bag and the bills therein should allow the filled bag to drop to the bottom of the safe. If not, the bag may be easily removed from the support tabs.

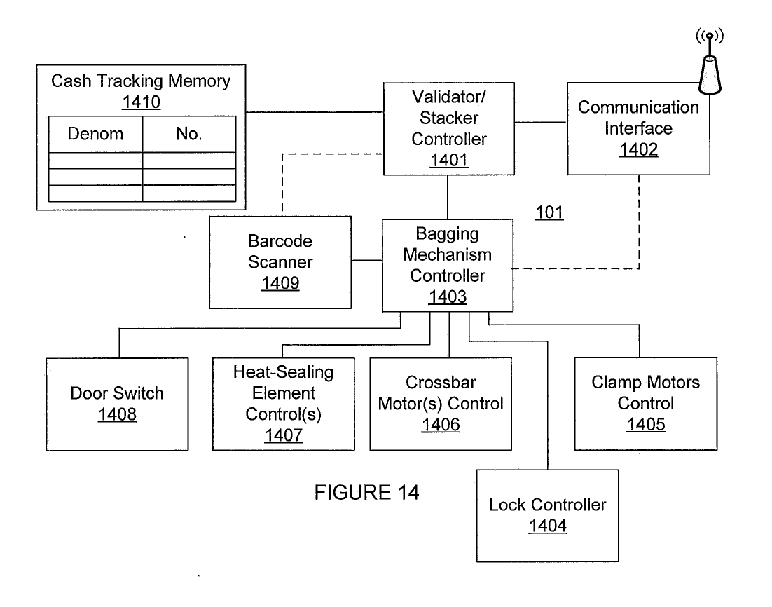

FIG. 14 is a block diagram of selected electrical and electronic components of a cash management safe 101 including a bill validator 201 and stacker 202 configured to store notes in sealing, tamper evident bags according to one embodiment of the present disclosure. The safe 101 includes a validator/stacker controller 1401 controlling operation of the bill validator 201 and the stacker 202. The validator/stacker controller 1401 is communicably coupled to a communication interface 1402, which is preferably a wireless communication link to a WAN including a remote cash management server for the enterprise as described above.

The validator/stacker controller 1401 is also communicably coupled to a controller 1403 for the bagging mechanism 204. In turn, the bagging mechanism controller 1403 is communicably coupled to a controller 1404 for the safe's door lock, a control 1405 for actuating the clamp motors, a control 1406 for actuating the motor(s) moving crossbar(s), a control 1407 for selectively energizing the heat-sealing element, a door switch 1408 sensing when the door 104 is opened or closed, and a barcode scanner 1409. The bagging mechanism controller 1403 may optionally have a direct communication link to the communication interface 1402, for communicating directly with systems external to the safe 101.

The bagging mechanism controller 1403 performs the process described above in connection with FIG. 13, in response to signals from several other components. For instance, the bill validator/stacker controller keeps a running count of bills accumulated within the stacker 202 and subsequently dropped into the bag, and thus signals the bagging mechanism controller 1403 when a predetermined capacity of bag has been reached (and may subsequently lock the bill validator 201 against accepting any further bills until the bag has been replaced with an empty bag). In response to such a signal that the capacity has been reached, the bagging mechanism controller 1403 seals and releases the bag, and may actuate an indicator (not shown) that the bag needs to be replaced. For example, one of several status indicators on the safe 101 (e.g., light emitting diodes on the safe's electronic lock mechanism) may indicate, among other status conditions, when the bag needs to be replaced with an empty bag. In addition, the bagging mechanism controller 1403, upon sealing and releasing a full bag, should send a signal to the bill validator/stacker controller 1401 to prevent any further accumulated bills from being released from the stacker 202.

The bagging mechanism control 1403 should also cooperate with the lock controller 1404 within the locking mechanism on the safe door. The safe door should preferably not be opened while a bag containing cash remains unsealed within the safe 101. Accordingly, the lock controller 1404 should signal the bagging mechanism controller 1403 when the correct combination is entered on the lock, and await a response before opening the safe door. The bagging mechanism controller 1403 can either promptly return the signal to unlock the safe if the bag has already been sealed and released, or can seal and release an open bag before returning the signal to open the lock. Again, a status indicator on the lock can indicate that the bag is being sealed while the user is waiting for to the door to unlock after entering the correct combination.

Finally, the bagging mechanism controller 1403, the bill validator/stacker controller 1401, or both should run a timer corresponding to a predetermined period during which cash is to be accumulated by the enterprise within the safe 101. For example, an enterprise may schedule a daily cash pickup by the CIT service. At the expiration of such period, the safe 101 should release any bills accumulated within the stacker 202 into the bag and seal and release the bag in preparation for removal from the safe 101.

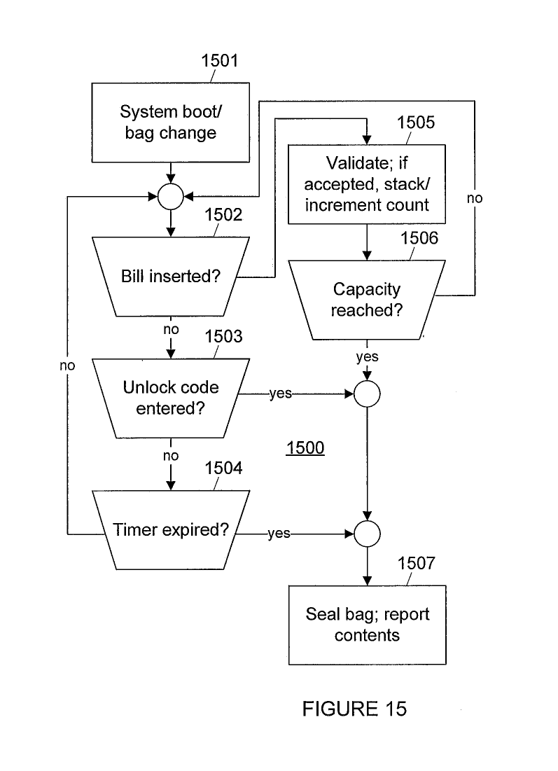

FIG. 15 is a high level flow chart of a process for operating a cash management safe including a bill validator and stacker configured to store notes in sealing, tamper evident bags according to one embodiment of the present disclosure. The process 1500 illustrated is cooperatively performed by one or more of the bill validator/stacker controller 1401, bagging mechanism controller 1403 and lock controller 1404, or alternatively by a central controller for safe 101.

The process begins with either a system boot or a bag change event (step 1501) inserting a new, empty bag into the safe 101. If a filled bag is being replaced within the bagging mechanism by an enterprise employee, the sealed bag may be simply stored at the bottom of the safe 101 until pickup by a CIT service. Because the bags are tamper-evident and the employee never has access to an unsealed bag containing cash deposited into the safe 101, the possibility of loss due to employee theft before pickup by the CIT service is reduced.

Each bag has a unique identifier on a barcode thereon, at a position in which the barcode can be scanned by barcode scanner 1409 within the safe 101. When a new bag is inserted into the bagging mechanism and the safe door 104 is closed, the barcode scanner 1409 reads the barcode identifier for the new bag. This is stored by at least bagging mechanism controller 1403, and may be communicated by bagging mechanism controller 1403 to bill validator/stacker controller 1401. Alternatively, barcode scanner 1409 may be directly coupled to bill validator/stacker controller 1401.

Once the system boot or bag change event (step 1501) is complete, the process 1500 enters a polling loop checking for insertion of a bill into the bill validator (step 1502), entry of the unlock code for the safe lock (step 1503) or expiration of a cash accumulation period timer (step 1504). If a bill is inserted into the bill validator, the authenticity of the bill is checked (step 1505). The denomination of the inserted bill is also determined, and also optionally checked against a set of denominations that the bill validator 201 is programmed to accept. Preferably, however, bill validator 201 is programmed to accept any denomination of bill in a given type of currency. If the inserted bill is accepted by the bill validator 201, the bill is stacked by stacker 202 and an internal count of accumulated bills within the stacker 202 is incremented. Preferably, the denomination of the inserted bill is also used to increment a count of bills of each denomination received within bill tracking memory 1410 within or coupled to bill validator/stacker controller 1401. Thus, the bill tracking memory 1410 contains a current count of accumulated bills within the stacker 202 by denomination (e.g., 47 twenty dollar bills, 19 ten dollar bills, 33 five dollar bills, and 78 one dollar bills).

When a bill is accepted (step 1505), a determination is made as to whether the capacity of the bag has been reached (step 1506). If not, the process resumes the polling loop (steps 1502 through 1504). If the capacity of the bag has been reached, however, or if the unlock code has been entered or the cash accumulation period elapsed, the bag is sealed (step 1507) in the manner described above. The bag identifier and the contents of the bag are also reported by the safe 101 (either by the bill validator/stacker controller 1401 or by the bagging mechanism controller 1403) to the remote cash management server 102. That report may be used for accounting purposes and/or to reconcile an amount credited at a deposit institution to which the bag is conveyed by a CIT service. The CIT service may, of course, scan the barcodes of all cash bags picked up from a retail establishment and delivered directly to the deposit institution.

The present disclosure allows bills accumulated in the course of retail operations to be validated and counted as those bills are deposited into a cash management safe, then stored securely in sealed, tamper-evident bags until delivered to a deposit institution by a CIT service. When a bag within the safe is full, a new bag can be installed without leaving an opportunity for employee pilferage since the cash is in a sealed bag. The employee must thus steal the entire bag of cash, or make evident any tampering with the bag that would be required to steal just part of the cash therein. The system of the present disclosure is compact and can be integrated with a point-of-sale terminal including an automatic change dispenser, to virtually eliminate any direct handling of cash by employees.

Although the present disclosure has been described with exemplary embodiments, various changes and modifications may be suggested to one skilled in the art. It is intended that the present disclosure encompass such changes and modifications as fall within the scope of the appended claims.

What is claimed is:

1. A cash management safe, comprising:
a secure enclosure having a locking, movable door selectively permitting access to an interior of the secure enclosure;
a bill validator mounted within the secure enclosure with an access slot for inserting a bill into the bill validator accessible from outside the secure enclosure;
a bill stacker mounted within the secure enclosure and configured to receive and stack bills from the bill validator; and
at least one bagging mechanism within the secure enclosure below the bill stacker, the at least one bagging mechanism including
a shroud blocking access through the door to a region of the secure enclosure within which the bill validator and the bill stacker are mounted,
crossbar members including support tabs configured to selectively hold end portions of a tamper-evident bag, at least one of the crossbar members movable toward or away from the other crossbar member, and
one or more movable heating platens mounted below the support tabs, the heating platens configured to heat and seal the neck portion of the tamper-evident bag.

2. The cash management safe of claim 1, wherein ends of the tamper-evident bag fold over the support tabs.

3. The cash management safe of claim 1, wherein the bill stacker is configured to release stacks of bills to fall into the tamper evident bag.

4. The cash management safe of claim 3, wherein, when the tamper-evident bag holds bills released from the bill stacker, the cash management safe is configured to seal the tamper-evident bag before allowing the door to be opened.

5. The cash management safe of claim 1, wherein the crossbars members are both movable.

6. The cash management safe of claim 1, comprising a plurality of the bagging mechanisms within the secure enclosure.

7. The cash management safe of claim 1, further comprising:
a printed indicia reader mounted within the secure enclosure configured to read printed indicia on the tamper-evident bag.

8. The cash management safe of claim 1, further comprising:
a communications link configured to allow communication between the cash management safe and a remote cash management server.

9. The cash management safe of claim 8, wherein a controller within the cash management safe is configured to report a value of the bills accepted by the bill validator to the remote cash management server using the communications link prior to the door being allowed to open.

10. The cash management safe of claim 1, wherein a controller within the cash management safe is configured to track at least one of a number of bills accepted by the bill validator and denominations of bills accepted by the bill validator.

11. A method of operating a cash management safe, comprising:
locking a movable door selectively permitting access to an interior of a secure enclosure;
receiving bills inserted into an access slot for a bill validator mounted within the secure enclosure, the access slot accessible from outside the secure enclosure;
stacking bills accepted by the bill validator using a bill stacker mounted within the secure enclosure and configured to receive and stack bills from the bill validator; and
receiving one or more bills from the bill stacker into a tamper-evident bag held by a bagging mechanism within the secure enclosure below the bill stacker, the bagging mechanism including
a shroud blocking access through the door to a region of the secure enclosure within which the bill validator and the bill stacker are mounted,
crossbar members including support tabs configured to selectively hold end portions of the tamper-evident bag, at least one of the crossbar members movable toward or away from the other crossbar member, and
one or more movable heating platens mounted below the support tabs, the heating platens configured to heat and seal the neck portion of the tamper-evident bag.

12. The method of claim 11, wherein ends of the tamper-evident bag fold over the support tabs.

13. The method of claim 11, wherein the bill stacker is configured to release stacks of bills to fall into the tamper evident bag.

14. The method of claim 13, further comprising:
when the tamper-evident bag holds bills released from the bill stacker, sealing the tamper-evident bag before allowing the door to be opened.

15. The method of claim 11, wherein the crossbars members are both movable.

16. The method of claim 11, comprising:
using a plurality of the bagging mechanisms mounted within the secure enclosure.

17. The method of claim 11, further comprising:
reading printed indicia on the tamper-evident bag using a printed indicia reader mounted within the secure enclosure.

18. The method of claim 11, further comprising:
communicating with a remote cash management server.

19. The method of claim 18, further comprising:
reporting a value of the bills accepted by the bill validator to the remote cash management server prior to allowing the door to open.

20. The method of claim 11, further comprising:
tracking at least one of a number of bills accepted by the bill validator and denominations of bills accepted by the bill validator.
